(19) United States
(12) Patent Application Publication
(10) Pub. No.: US 2007/0005423 A1
(43) Pub. Date: Jan. 4, 2007

(54) Providing promotional content

(75) Inventors: Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/174,432

(22) Filed: Jul. 1, 2005

Related U.S. Application Data
(63) Continuation-in-part of application No. 11/173,990, filed on Jul. 1, 2005.

(51) Int. Cl. G06Q 30/00

(52) U.S. Cl. 705/14

(57) ABSTRACT

An apparatus, device, methods, computer program product, and system that receive a media asset from a consumer, and process the media asset in association with an agreement with the consumer to create a processed media asset, where the processing includes modifying a portion of the media asset with promotional content for provision of the processed media asset to the consumer.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. Kunin, Benefit of Prior-Filed Application, USPTO Electronic Official Gazette, Mar. 18, 2003 at http://www.uspto.gov/web/offices/com/sol/og/2003/week11/patbene.htm. The present applicant entity has provided below a specific reference to the application(s)from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### RELATED APPLICATIONS

1. For purposes of the USPTO extra-statutory requirements, the present application constitutes a continuation in part of currently co-pending United States patent application entitled TECHNIQES FOR IMAGE GENERATION, naming Royce A. Levien; Robert W. Lord; Mark A. Malamud and John D. Rinaldo, Jr., as inventors, USAN: To be Assigned, filed Jul. 1, 2005.

### SUMMARY

An embodiment provides a method. In one implementation, the method includes but is not limited to receiving a media asset from a consumer, processing the media asset in association with an agreement with the consumer to create a processed media asset, the processing including modifying a portion of the media asset with promotional content, and providing the processed media asset to the consumer. In addition to the foregoing, other method aspects are described in the claims, drawings, and text forming a part of the present disclosure.

An embodiment provides a computer program product. In one implementation, the computer program product includes but is not limited to a signal bearing medium bearing at least one of one or more instructions for receiving a media asset from a consumer; one or more instructions for processing the media asset in association with an agreement with the consumer to create a processed media asset, the processing including modifying a portion of the media asset with promotional content; or one or more instructions for providing the processed media asset to the consumer. In addition to the foregoing, other computer program product aspects are described in the claims, drawings, and text forming a part of the present disclosure.

An embodiment provides a system. In one implementation, the system includes but is not limited to a computing device and instructions. The instructions when executed on the computing device cause the computing device to receive a media asset from a consumer, process the media asset in association with an agreement with the consumer to create a processed media asset, the processing including modifying a portion of the media asset with promotional content, and provide the processed media asset to the consumer. In addition to the foregoing, other system aspects are described in the claims, drawings, and text forming a part of the present disclosure.

An embodiment provides a device. In one implementation, the device includes but is not limited to a processing system, and the processing system includes processing logic operable to process a media asset in association with an agreement with a consumer to create a processed media asset, and modification logic operable to modify a portion of the media asset based on promotional content for inclusion in the processed media asset as provided to the consumer. In addition to the foregoing, other device aspects are described in the claims, drawings, and text forming a part of the present disclosure.

An embodiment provides another method. In one implementation, the method includes but is not limited to providing a media asset to a processing system, specifying a processing of the media asset by which a processed media asset is produced, the processing including modifying a portion of the media asset with promotional content, and receiving the processed media asset. In addition to the foregoing, other method aspects are described in the claims, drawings, and text forming a part of the present disclosure.

In addition to the foregoing, various other embodiments are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices and/or processes described herein, as defined by the claims, will become apparent in the detailed description set forth herein.

### BRIEF DESCRIPTION OF THE DRAWINGS

FIG. 1 illustrates an example system in which embodiments may be implemented, including a general-purpose computing device.

FIG. 2 illustrates an operational flow representing example operations that provide a processed media asset that includes promotional content to a consumer.

FIG. 3 illustrates an alternative embodiment of the example operational flow of FIG. 2.

FIG. 4 illustrates an alternative embodiment of the example operational flow of FIG. 2.

FIG. 5 illustrates another alternative embodiment of the example operational flow of FIG. 2.

FIG. 6 illustrates another alternative embodiment of the example operational flow of FIG. 2.

FIG. 7 illustrates another alternative embodiment of the example operational flow of FIG. 2.

FIG. 8 illustrates an alternative embodiment of the example operational flow of FIG. 2.

FIG. 9 illustrates an alternative embodiment of the example operational flow of FIG. 2.

FIG. 10 illustrates an alternative embodiment of the example operational flow of FIG. 2.

FIG. 11 illustrates an alternative embodiment of the example operational flow of FIG. 2.

FIG. 12 illustrates a partial view of an example computer program product that includes a computer program for executing a computer process on a computing device.

FIG. 13 illustrates an example system in which embodiments may be implemented.

FIG. 14 illustrates another example system in which embodiments may be implemented, perhaps in the context of a device.

FIGS. 15A-15C illustrate certain alternative embodiments of the device and/or processing system of FIG. 14.

FIG. 16 illustrates an operational flow representing example operations by which a consumer obtains a processed media asset that includes promotional content.

The use of the same symbols in different drawings typically indicates similar or identical items.

### DETAILED DESCRIPTION

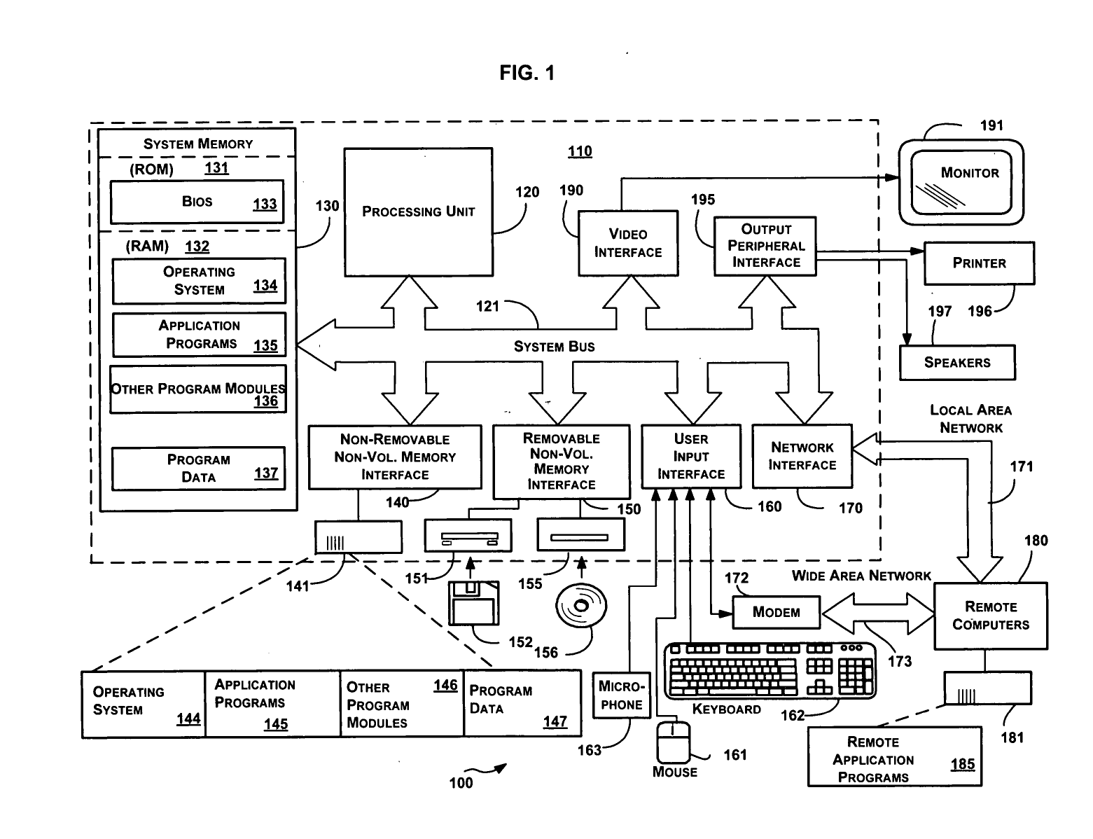

FIG. 1 and the following discussion are intended to provide a brief, general description of an environment in which embodiments may be implemented. FIG. 1 illustrates an example electronic device that may correspond in whole or part to a general-purpose computing device, and is shown as a computing system environment 100. Components of the computing system environment 100 may include, but are not limited to, a computing device 110 having a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media and communications media.

Computer storage media includes both volatile and nonvolatile, removable and non-removable media implemented in any method or technology for storage of information such as computer-readable instructions, data structures, program modules, or other data. Computer storage media include, but are not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110.

Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media such as a wired network and a direct-wired connection and wireless media such as acoustic, RF, optical, and infrared media. Combinations of any of the above should also be included within the scope of computer-readable media.

The system memory 130 includes computer storage media in the form of volatile and nonvolatile memory such as ROM 131 and RAM 132. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by processing unit 120. By way of example, and not limitation, FIG. 1 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” are well known in the art.

The computing device 110 may also include other removable/non-removable, volatile/nonvolatile computer storage media products. By way of example only, FIG. 1 illustrates a non-removable non-volatile memory interface (hard disk interface) 140 that reads from and writes to non-removable, non-volatile magnetic media, a magnetic disk drive 151 that reads from and writes to a removable, non-volatile magnetic disk 152, and an optical disk drive 155 that reads from and writes to a removable, non-volatile optical disk 156 such as a CD ROM. Other removable/nonremovable, volatile/non-volatile computer storage media that can be used in the example operating environment include, but are not limited to, magnetic tape cassettes, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 1 provide storage of computer-readable instructions, data structures, program modules, and other data for the computing device 110. In FIG. 1, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies. A user may enter commands and information into the computing device 110 through input devices such as a microphone 163, keyboard 162, and pointing device 161, commonly referred to as a mouse, trackball, or touch pad. Other input devices (not shown) may include a joystick, game pad, satellite dish, and scanner. These and other input devices are often connected to the processing unit 120 through a user input interface 160 that is coupled to the system bus, but may be connected by other interface and bus structures, such as a parallel port, game port, or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 1. The logical connections depicted in FIG. 1 include a local area network (LAN) 171 and a wide area network (WAN) 173, but may also include other networks such as a personal area network (PAN) (not shown). Such networking environments are commonplace in offices, enterprise-wide computer networks, intranets, and the Internet.

When used in a LAN networking environment, the computing system environment 100 is connected to the LAN 171 through a network interface or adapter 170. When used in a WAN networking environment, the computing device 110 typically includes a modem 172 or other means for establishing communications over the WAN 173, such as the Internet. The modem 172, which may be internal or external, may be connected to the system bus 121 via the user input interface 160, or via another appropriate mechanism. In a networked environment, program modules depicted relative to the computing device 110, or portions thereof, may be stored in a remote memory storage device. By way of example, and not limitation, FIG. 1 illustrates remote application programs 185 as residing on memory device 181. It will be appreciated that the network connections shown are examples and other means of establishing a communications link between the computers may be used.

In the description that follows, certain embodiments may be described with reference to acts and symbolic representations of operations that are performed by one or more computing devices, such as computing device 110 of FIG. 1. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Thus, FIG. 1 illustrates an example of a suitable environment on which embodiments may be implemented. The computing system environment 100 of FIG. 1 is an example of a suitable environment and is not intended to suggest any limitation as to the scope of use or functionality of an embodiment. Neither should the environment be interpreted as having any dependency or requirement relating to any one or combination of components illustrated in an example operating environment.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, server computers, hand-held or laptop devices, personal digital assistants, multiprocessor systems, microprocessor-based systems, set top boxes, programmable consumer electronics, network, minicomputers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in distributed computing environments where tasks are performed by remote processing devices that are linked through a communications network. In a distributed computing environment, program modules may be located in both local and remote computer storage media including memory storage devices.

The following include a series of illustrations depicting implementations of processes. For ease of understanding, certain illustrations are organized such that the initial illustrations present implementations via an overall “big picture” viewpoint and thereafter the following illustrations present alternate implementations and/or expansions of the “big picture” illustrations as either sub-steps or additional steps building on one or more earlier-presented illustrations. This style of presentation utilized herein (e.g., beginning with a presentation of a illustration(s) presenting an overall view and thereafter providing additions to and/or further details in subsequent illustrations) generally allows for a rapid and easy understanding of the various process implementations. In addition, those skilled in the art will further appreciate that the style of presentation used herein also lends itself well to modular and/or object-oriented program design paradigms.

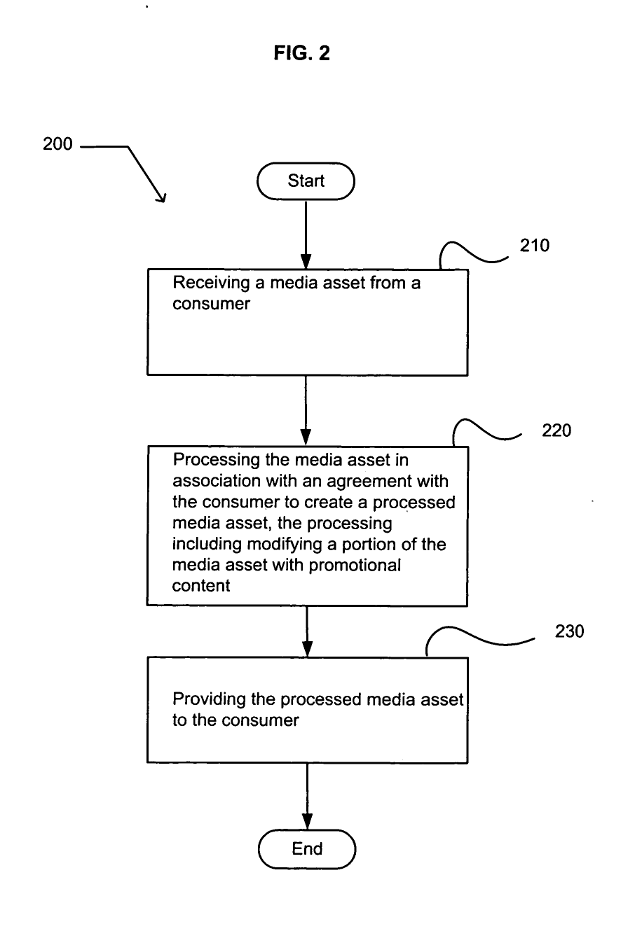

FIG. 2 illustrates an operational flow representing example operations that provide a processed media asset that includes promotional content to a consumer. After a start operation, the operational flow 200 moves to a receiving operation 210 where a media asset is received from a consumer. At processing operation 220, the media asset is processed in association with an agreement with the consumer to create a processed media asset, and, in particular, a portion of the media asset is modified with promotional content. At a providing operation 230, the processed media asset is then provided to the consumer (230). The operational flow 200 then moves to an end operation.

In some embodiments, a consumer may include a person, an entity, and/or a government. Although a consumer may be shown herein as a single illustrated figure, and/or be described in the singular, those skilled in the art will appreciate that the term consumer may be representative of one or more human user(s), robotic user(s) (e.g., computational entity), and/or substantially any combination thereof (e.g., a consumer may be assisted by one or more robotic agents). Further, the consumer, as set forth herein, even if shown as a single entity, may in fact be composed of two or more entities. Those skilled in the art will appreciate that, in general, the same may be said of “sender” and/or other entity-oriented terms as such terms are used herein.

In some embodiments, a media asset may include a visual image, a picture, a website, an audio recording, a video stream, and/or an audio stream. In additional or alternative embodiments, the media asset also may include text, such as may be included in an article or other writing, or in a website. The media asset may be embodied in various forms, including but not limited to digital files or transmissions, analog recordings or transmissions, or may be embodied in physical form, such as, for example, on paper, plastic, canvas, wood, or any other physical medium in which text, image, or other representations may be embodied. The media asset may be received, stored and/or transmitted using the elements of the computer environment 100 described above, or using other elements. The media asset may be transmitted over a local area network (LAN), a wide area network (WAN), or a peer-to-peer (P2P) network, or may be broadcast over the air. The media asset may be captured, received, displayed and/or transmitted, for example and without limitation, using one or more of the following: an electronic device; an appliance; a computing device, such as a personal computer and a server; a limited resource computing device; a pervasive computing device; a personal digital assistant (PDA); a cell phone; a Blackberry appliance; a vehicle, such as a car, boat, and/or aircraft; an X-Box; a home gateway; a set-top box; a television, a radio, a camera; a printer; a digital video disc (DVD) recorder or burner; and a TiVo or other digital video recorder (DVR).

The promotional content may include virtually any content or type of content that may be used to modify the portion of the media asset, including, but not limited to, all of the various types of content discussed above with respect to the media asset itself. As such, a form of the promotional content may be dependent on, or related to, a form of the media asset. For example, in an example embodiment in which the media asset includes a digital image, then the promotional content also may be a digital image that may be used to modify the portion of the digital image of the media asset. For example, the media asset may include a digital image of a particular item or other content, such as, for example, a person, place, or thing, and, in this case, the promotional content may be a branded or sponsored logo, slogan, or image with which the item or other content may be replaced or otherwise modified.

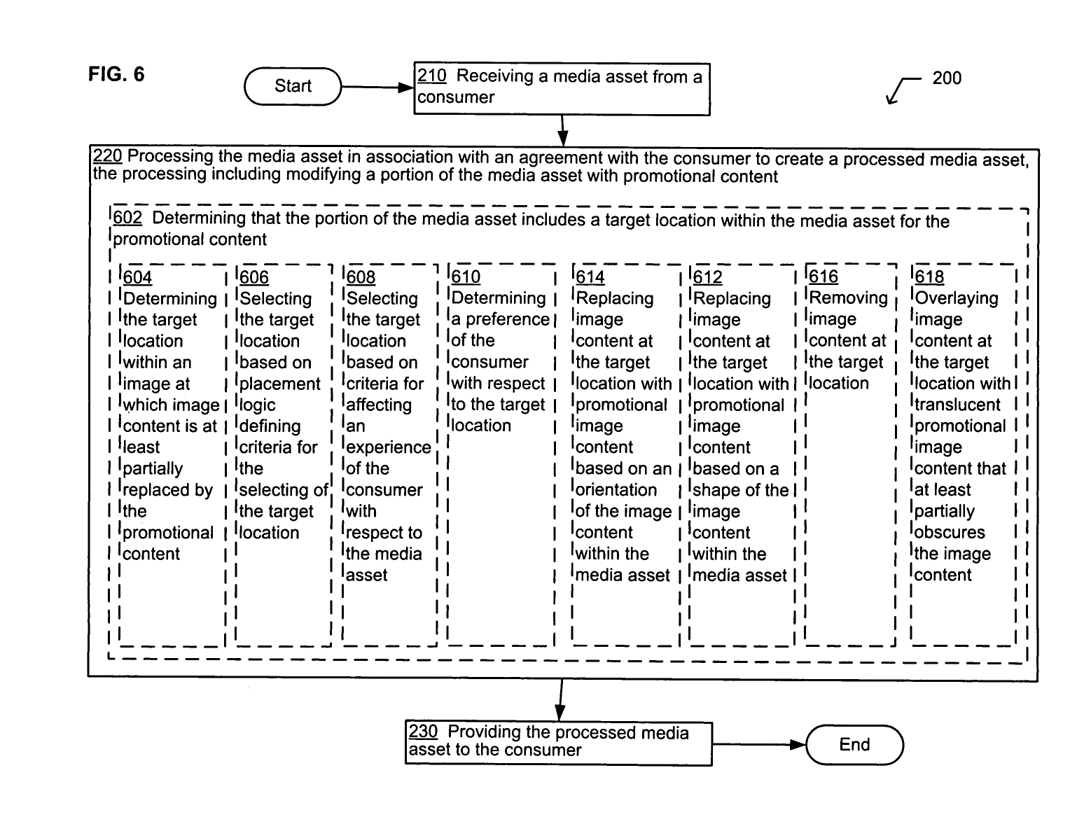

For example, the promotional content may include a logo or slogan associated with a particular corporate entity, so that, for example, a Coke logo or slogan may be used as the promotional content to modify the portion of the media asset. In one example embodiment, a Coke logo may simply be placed into a portion of the digital image where other substantive content is minimized, such as, for example, within a sky or other background portion of the digital image, as opposed to within a face of a subject of the digital image, or where other substantive content is included. In other example embodiments, the promotional content may include an actual image of an item, such as, for example, a can of Coke, and this item may be placed into the digital image. In particular, in one example, such an image of a can of Coke may be inserted into the digital image so as to replace or otherwise obscure a can of another brand of cola or other beverage. Other examples of types of promotional content, as well as other examples of techniques for modifying the portion of the media asset with the promotional content, and for processing the media asset in general, are discussed in more detail below, and, in particular, with respect to FIGS. 6-9.

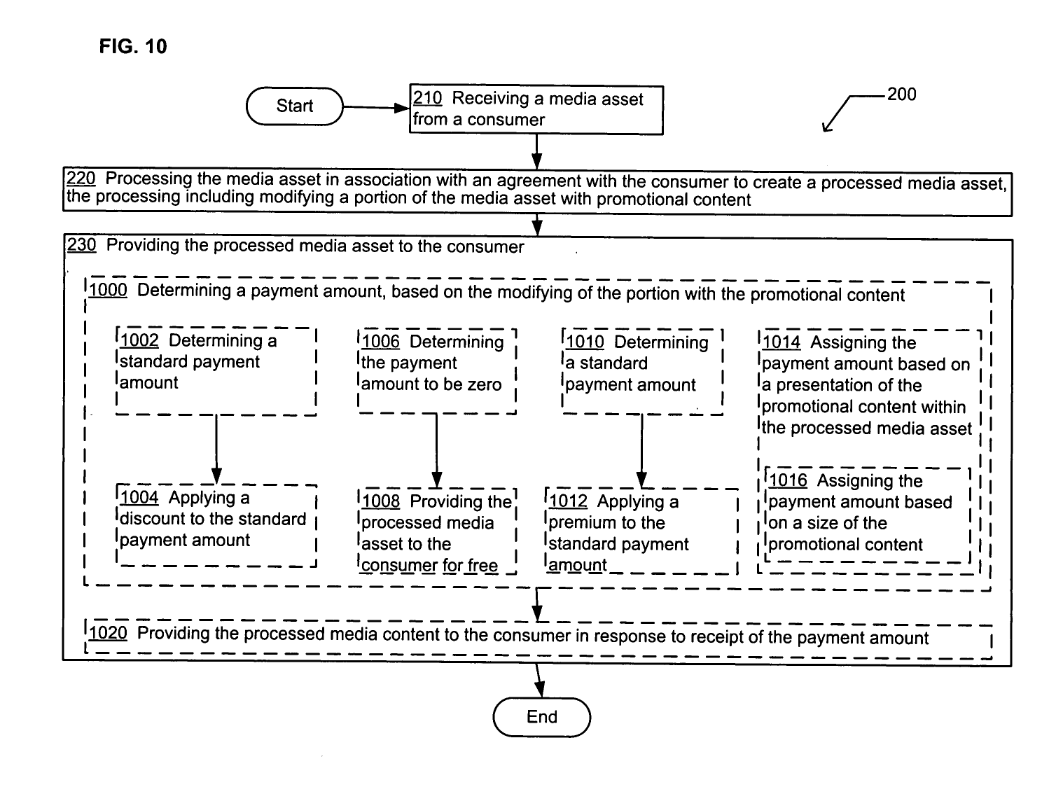

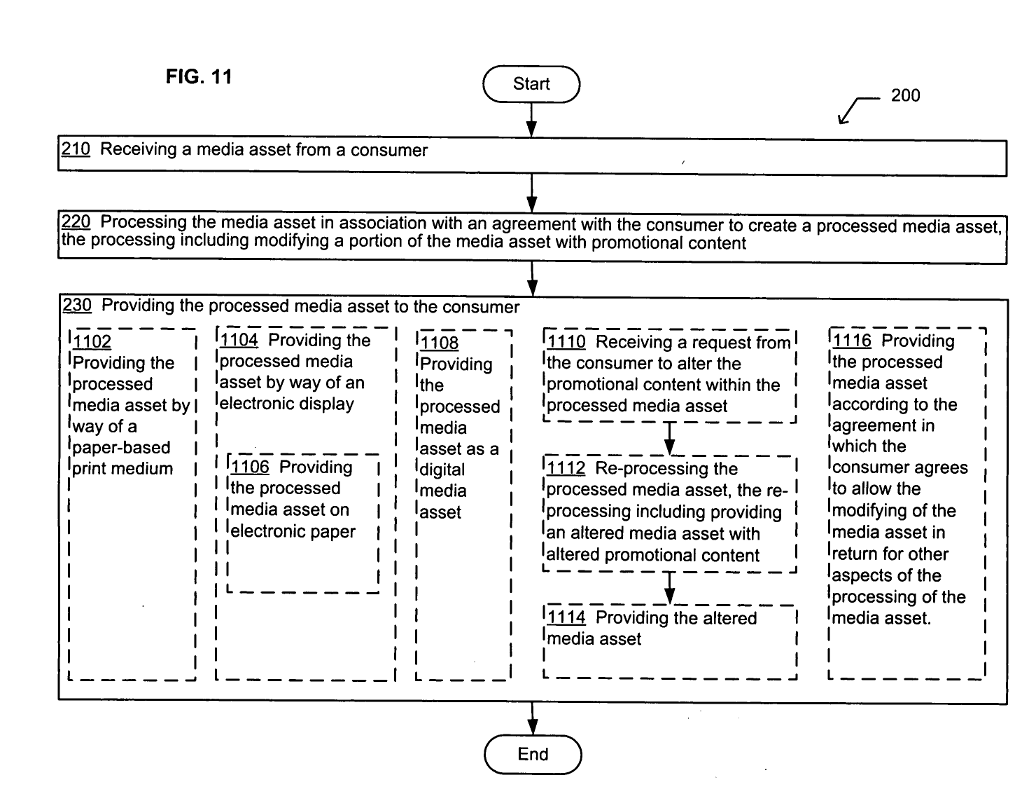

Providing the processed media asset to the consumer may include any form of transmission, production, display, presentation or output of the processed media asset, and may be performed according to the agreement with the consumer. In particular, in some example embodiments, payment terms, by which the consumer pays for the processing of the media asset and/or for an associated processing device, may be determined such that the consumer pays more or less than would normally be required (or pays nothing), based on the agreement and/or the modifying of the media asset using the promotional content. In some examples, then, a corporate or other sponsoring entity may be said to subsidize a cost of the processing and/or a device for performing the processing. Other examples of providing the media asset to the consumer are discussed in more detail below, and, in particular, with respect to FIGS. 10-11.

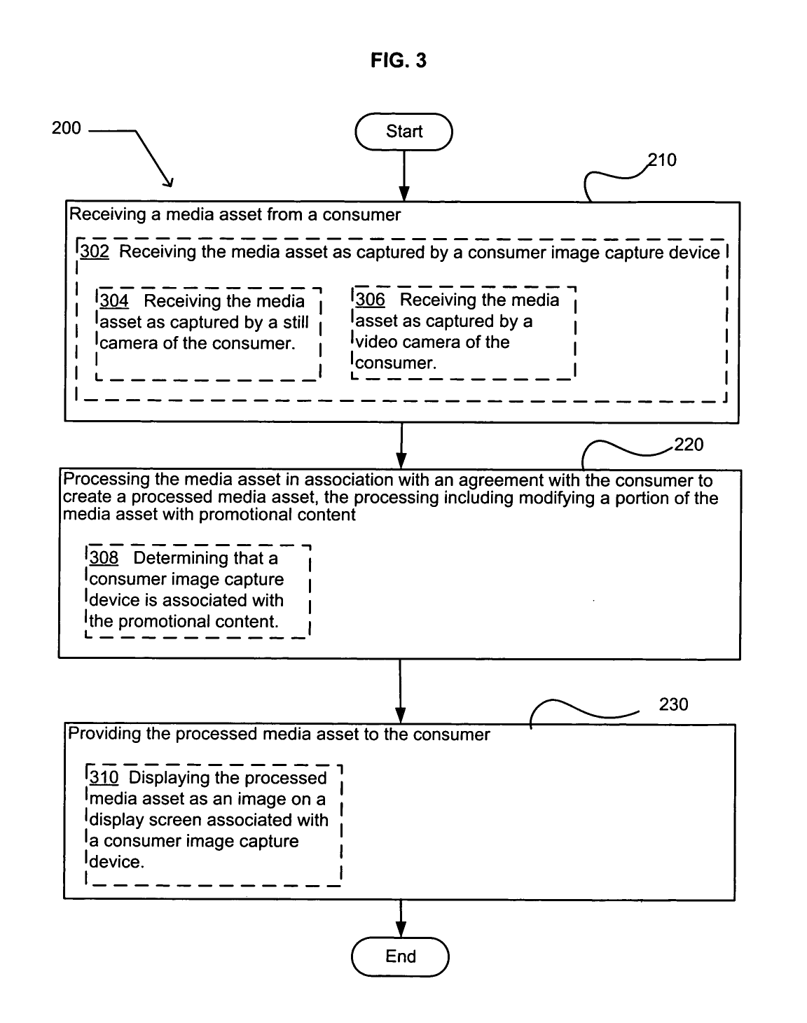

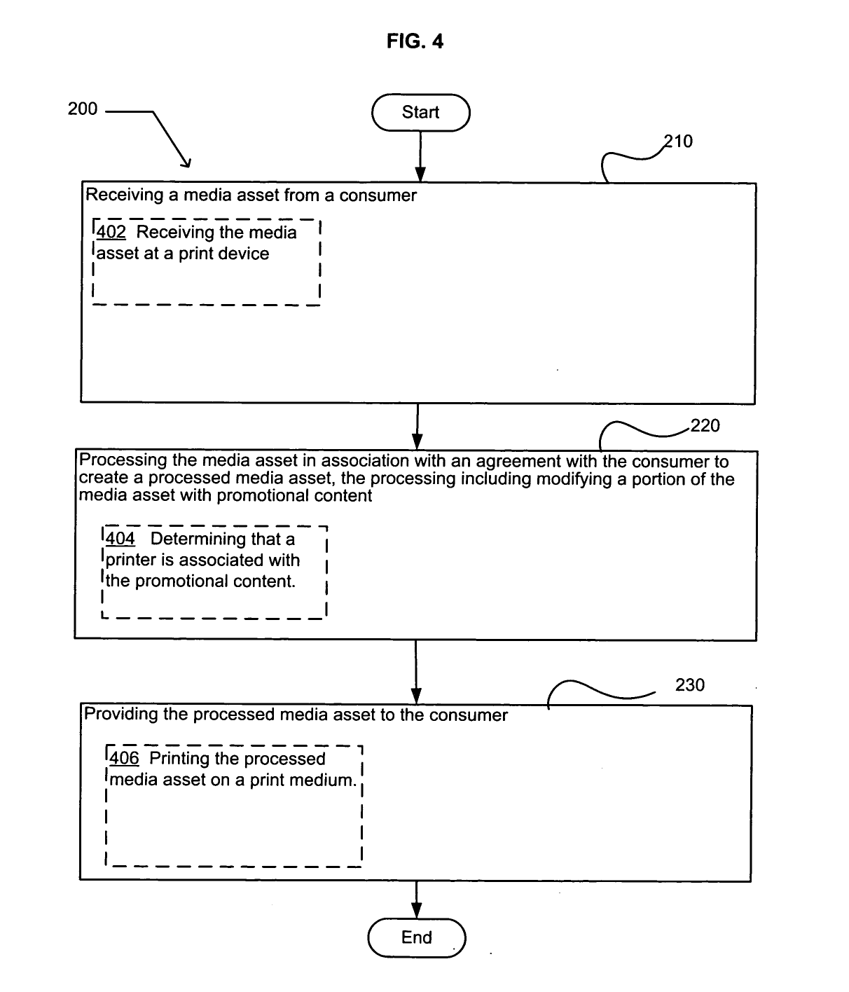

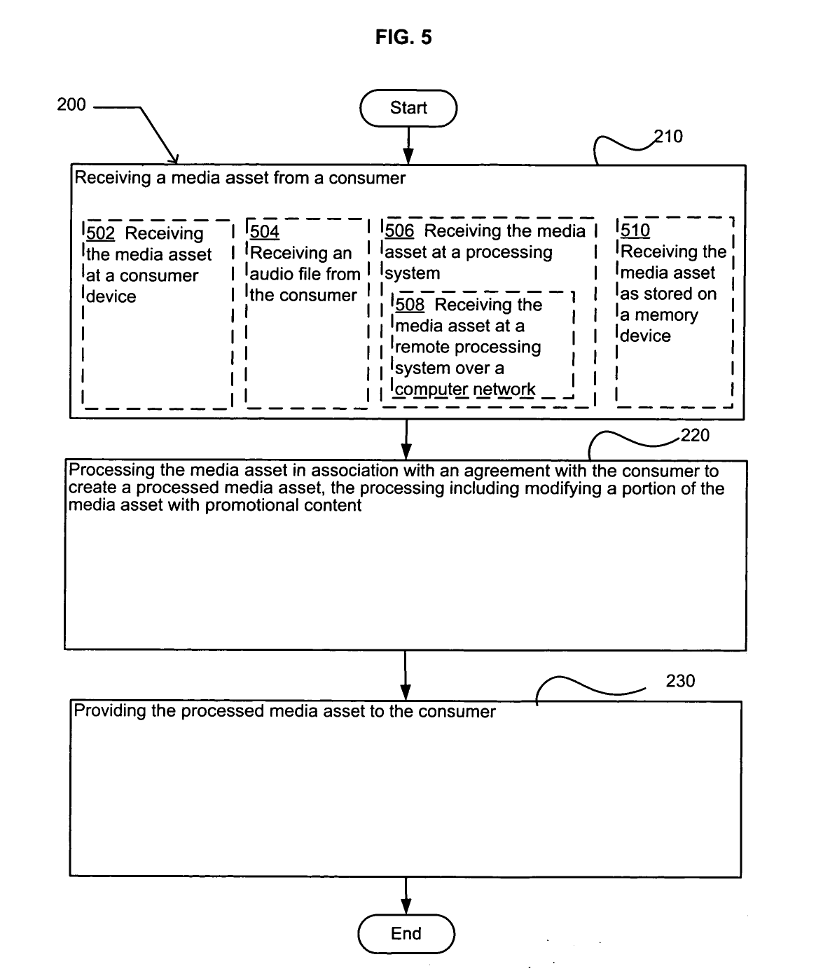

FIG. 3 illustrates an alternative embodiment of the example operational flow 200 of FIG. 2. FIG. 3 illustrates an example embodiment where the receiving operation 210, the processing operation 220, and/or the providing operation 230 may include at least one additional operation. Additional operations may include operation 302, operation 304, and operation 306. At the operation 302, the media asset is received as captured by a consumer image capture device. At the operation 304, the consumer image capture device includes a still camera of the consumer, while, at the operation 306, the media asset is captured by a video camera of the consumer. Of course, the media asset also may be captured by other consumer image capture devices or other devices in general, as discussed in more detail below, and, in particular, as discussed with respect to FIGS. 4 and 5.

Also in FIG. 3, the processing operation 220 may include at least one additional operation. Additional operations may include operation 308. At the operation 308, it is determined that the consumer image capture device referenced above is associated with the promotional content. That is, in one example embodiment, the consumer image capture device may be branded on its exterior with one or more logos or slogans of a corporate sponsor or other sponsoring entity. For example, a camera may be associated with Coke, so that the consumer may be aware that any picture captured by the camera may include Coke-sponsored content when displayed, viewed, printed, or otherwise rendered or output. The association of the consumer image capture device with the promotional content need not, however, be externally displayed or represented on the device itself, and, for example, may be stored within a memory of the consumer image capture device, or within some other memory with which the consumer image capture device may be in communication.

Also in FIG. 3, the providing operation 230 may include at least one additional operation. Additional operations may include operation 310. At the operation 310, the processed media asset is displayed as an image on a display screen associated with the consumer image capture device. Thus, in one example embodiment, where the promotional content includes a representation of a Coke logo or Coke can, with which a portion of the media asset has been modified, the consumer is able to view a resulting processed media asset in which an image captured by the consumer is displayed with the Coke logo or Coke can. The operational flow 300 then moves to an end operation.

FIG. 4 illustrates an alternative embodiment of the example operational flow 200 of FIG. 2. FIG. 4 illustrates an example embodiment where the receiving operation 210, the processing operation 220, and/or the providing operation 230 may include at least one additional operation. Additional operations may include operation 402, operation 404, and operation 406, respectively.

At the operation 402, the media asset is received at a print device. In one example embodiment, the media asset is received at the print device from a computer (including a computer such as a server that may be remotely connected to a local computer), or directly from an image capture device, or from a memory card or other storage device or medium. At the operation 404, it is determined that the printer is associated with the promotional content. That is, for example, as in the examples already discussed, the printer may be externally, internally, or remotely associated with the promotional content, where the promotional content may include sponsored content from one or more corporate entities or other sponsoring entities. At the operation 406, the processed media asset is printed on a print medium. In an example embodiment, then, a consumer image, text, or other representation that has been captured or otherwise obtained by the consumer may be modified to include the sponsored content (e.g., logo, slogan, or item) within a printed version of the processed media asset.

FIG. 5 illustrates an alternative embodiment of the example operational flow 200 of FIG. 2. FIG. 5 illustrates another embodiment where the receiving operation 210 may include at least one additional operation. The additional operations may include operation 502, operation 504, operation 506, operation 508, and operation 510.

At operation 502, the media asset is received at a consumer device. That is, although the examples are given above of an image capture device and a print device, it should be understood that any appropriate consumer device may be used to receive the media asset, and, consequently, may be sponsored, branded, and/or subsidized by a corporate or other sponsor. For example, other consumer devices that may be sponsored, branded, and/or subsidized may include some or all of the various devices mentioned above for storing, displaying, or transmitting the media asset itself, including, for example, a memory card or other device, a PDA, a television, a PVR, a DVD recorder or burner, or a radio.

At operation 504, the media asset is received and includes an audio file. In this case, the promotional content that modifies the portion of the audio file may be an audio recording, such as, for example, a sound of a Harley-Davidson motorcycle. The promotional content may, in some examples, replace a portion of the audio file, or, in other example embodiments, may be used to modify a background portion of the audio file that will then be played together with the audio file when the audio file is selected for playing by the consumer.

At operation 506, the media asset is received at a processing system. As should be apparent from the above examples, the processing system may be deployed as part of, or in conjunction with, a consumer device. However, in other example embodiments, as in the operation 508, the processing system may be deployed at a remote processing system over a computer network. For example, the consumer may capture a digital image with a standard camera, and may then upload the digital image to a remote server at a processing service that is running the processing system. The consumer may then select the photo for printing as a standard 4×6 or 8×10 picture, which, as should be apparent, would then be modified by the processing system for printing so as to include certain promotional content. The resulting processed media asset would then be sent to the consumer for use and enjoyment, and a corresponding digital version also may be e-mailed or otherwise transmitted to the consumer, or burned onto a CD or other storage media for sending to the consumer. In this way, the consumer may receive versions, e.g., printed versions, of captured images for a free or reduced cost, as compared to if the consumer were to choose to pay for printed versions by way of standard processing techniques.

In a final example of FIG. 5, at operation 510, the media asset may be received as stored on a memory device. For example, the consumer may capture an audio and/or visual file using an image capture device or by way of downloading from a website or other location. The consumer may store the resulting digital file on a memory card, memory stick, CD, DVD, or other storage media, such as those discussed above with respect to FIG. 1. The digital image may then be received from the memory device for processing thereby to provide a processed digital image containing promotional content.

FIG. 6 illustrates an alternative embodiment of the example operational flow 200 of FIG. 2. FIG. 6 illustrates an embodiment where the processing operation 220 may include at least one additional operation. Additional operations may include operation 602, operation 604, operation 606, operation 608, operation 610, operation 612, operation 614, operation 616, and operation 618. At operation 602, the portion of the media asset is determined to include a target location within the media asset for the promotional content.

The operation 602 may include additional operations. For example, at operation 604, when the media asset is an image or other visual media asset, the target location within such an image may be determined at which image content is at least partially replaced by the promotional content. At operation 606, the target location is selected based on placement logic defining criteria for the selecting of the target location, so that, for example, a desired result may be achieved, such as, for example, minimizing or maximizing an impact of the promotional content on image as a whole. Thus, at operation 608, the target location is selected based on criteria for affecting an experience of the consumer with respect to the media asset. At operation 610, a preference of the consumer with respect to the target location is determined. For example, the consumer may wish that the promotional content is located within a specified corner or other location of the image. At operation 612, image content at the target location is replaced with the promotional image content based on a shape of the image content within the media asset. For example, if a shape of image content within the portion of the media asset to be replaced includes a can of cola, and if the promotional content is sponsored by Coke, then a shape of the promotional content may be determined to be a shape of a Coke can. At operation 614, image content at the target location is replaced with promotional image content based on an orientation of the image content within the media asset. For example, and continuing the example above of a Coke can, the inserted Coke can may be oriented, scaled, angled, or rotated so as to fit into the original image (media asset), with minimal impact on the image. In some example embodiments, the Coke can or other promotional content need not replace an analogous item, such as another can of cola. For example, promotional content such as the Coke can image may be shaped or oriented so as to appear appropriately within the image, e.g., situated on a table surface or in the hand of a person in the image.

At operation 616, image content is removed at the target location. For example, if a corporate or other sponsor sponsors a camera or printer, then that sponsor may desire that no image produced by such a device includes an image of competitors' products, so that the processing includes removal of specified items from the portion (e.g., target location) of the media asset (e.g., image). At operation 618, image content at the target location is overlaid with translucent promotional image content that at least partially obscures the image content. For example, a translucent logo or slogan may be overlaid at a corner or other location within the image.

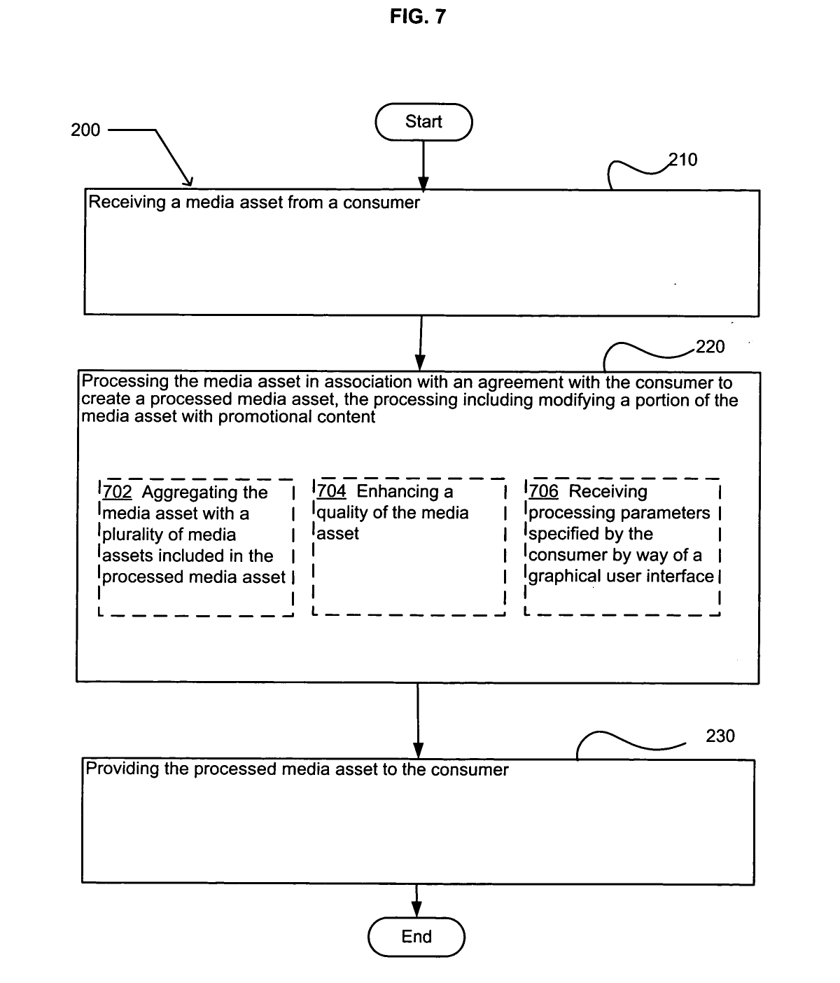

FIG. 7 illustrates an alternative embodiment of the example operational flow 200 of FIG. 2. FIG. 7 illustrates an embodiment where the processing operation 220 may include at least one additional operation. Additional operations may include operation 702, operation 704, and operation 706. At operation 702, the media asset is aggregated with a plurality of media assets included in the processed media asset. For example, in one embodiment, the media asset may be an image of the consumer, and the resulting processed image with promotional content may be aggregated together with other images, including, for example, other images of the consumer, or other images of the entity providing the promotional content, or audio files, website pages, or other media assets. At operation 704, a quality of the media asset is enhanced. For example, the consumer may provide an image or audio file, or an actual printed photograph that is of a certain quality. In processing such a media asset, a quality of the media asset may be improved, so that, for example, artifacts may be removed, colors may be balanced, contrast may be improved, and/or the image may be cropped, rotated, edited, or otherwise altered according to the consumer's wishes and/or according to some enhancement criteria. At operation 706, processing parameters specified by the consumer by way of a graphical user interface are received, so that the processing may proceed accordingly. For example, the various examples given above for target location selection, placement, replacement, modification, removal, size, orientation, aggregation, enhancement. Or other processing may be specified by way of the graphical user interface. Other processing or providing parameters also may be specified by way of the graphical user interface, such as, for example, payment terms associated with the processing of the media asset, and these examples are discussed in more detail below.

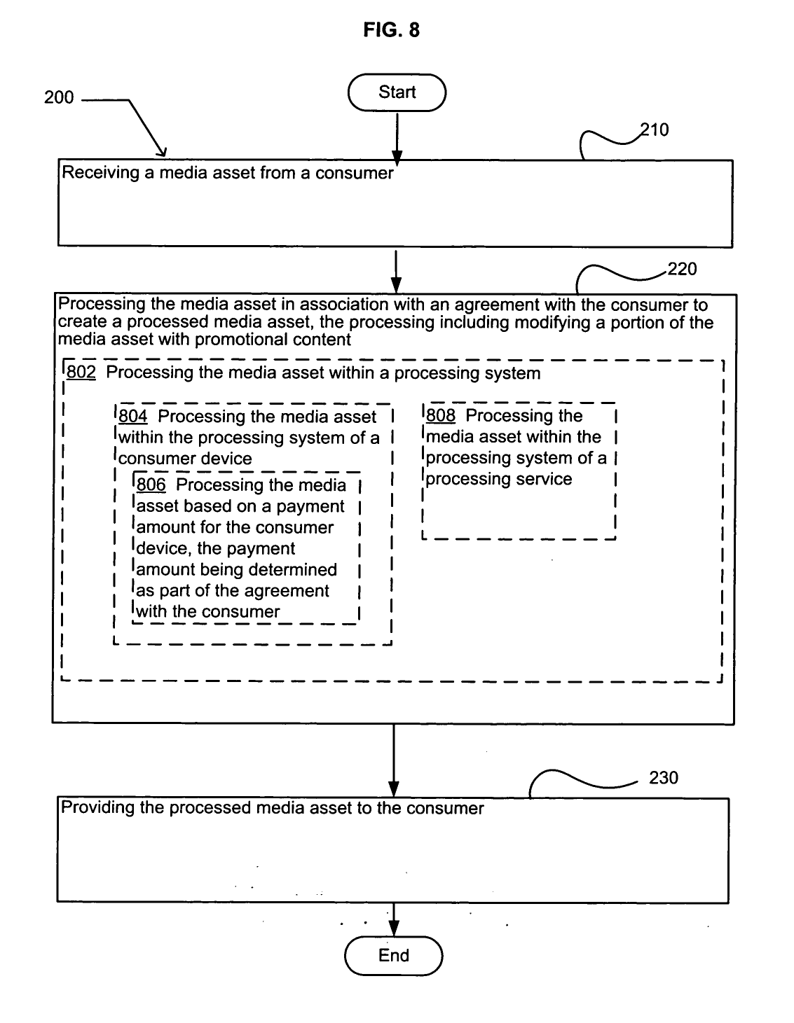

FIG. 8 illustrates an alternative embodiment of the example operational flow 200 of FIG. 2. FIG. 8 illustrates an embodiment where the processing operation 220 may include at least one additional operation. Additional operations may include operation 802, operation 804, operation 806, and operation 808. At operation 802, the media asset is processed within a processing system. The operation 802 may include the operation 804, in which the media asset is processed within the processing system of a consumer device. The operation 804 may include the operation 806, in which the media asset is processed based on a payment amount for the consumer device, the payment amount being determined as part of the agreement with the consumer.

Payment may refer generally to any type of monetary compensation, and/or non-monetary compensation, and/or economic value exchange. Such payment may, for example, occur between any pair of entities and/or other group of entities. By way of example and not limitation, a payment may include a non-monetary payment, such as a credit or coupon that may be exchanged for goods or services, a reduced or eliminated cost to a consumer or user for related or non-related goods or services. In another example, a payment may include granting a party certain rights or permissions as payment, such as information-related permissions. This may involve granting a party rights to certain information the party ordinarily would not have rights to access, or the right to use certain information in a particular manner. For example, one type of payment may include a party allowing another party to keep a user's personal information in a database for marketing or research purposes. In another example, as compensation or payment, a consumer or user may grant another party the right to monitor a computer usage, or preferences or buying habits of the consumer in certain contexts, or the right to monitor a physical location or activity of the consumer. The consumer also may accept cash or cash-equivalents as payment from the provider for providing such entitlements, rights, or permissions. Thus, by providing and/or receiving monetary or non-monetary value, in an amount that may be designated as part of an agreement between the relevant parties, the parties may gain advantages and benefits that are mutually acceptable to both.

In this way, for example, a consumer may agree to be provided with a camera or printer at significantly less cost than would normally be required, in return for the inclusion of the promotional content. Thus, for example, a consumer who may not otherwise be able to afford a camera or printer or other device of a certain quality may be able to afford a higher quality device, or a consumer who could not otherwise afford a particular consumer device may be able to obtain such a device. At the operation 808, the media asset is processed within the processing system of a processing service, and, as mentioned above, this processing service may be remote from the consumer, and, as should be apparent from the above discussion, may allow the consumer to obtain prints, productions, or other processed digital media at a reduced cost than would otherwise be available.

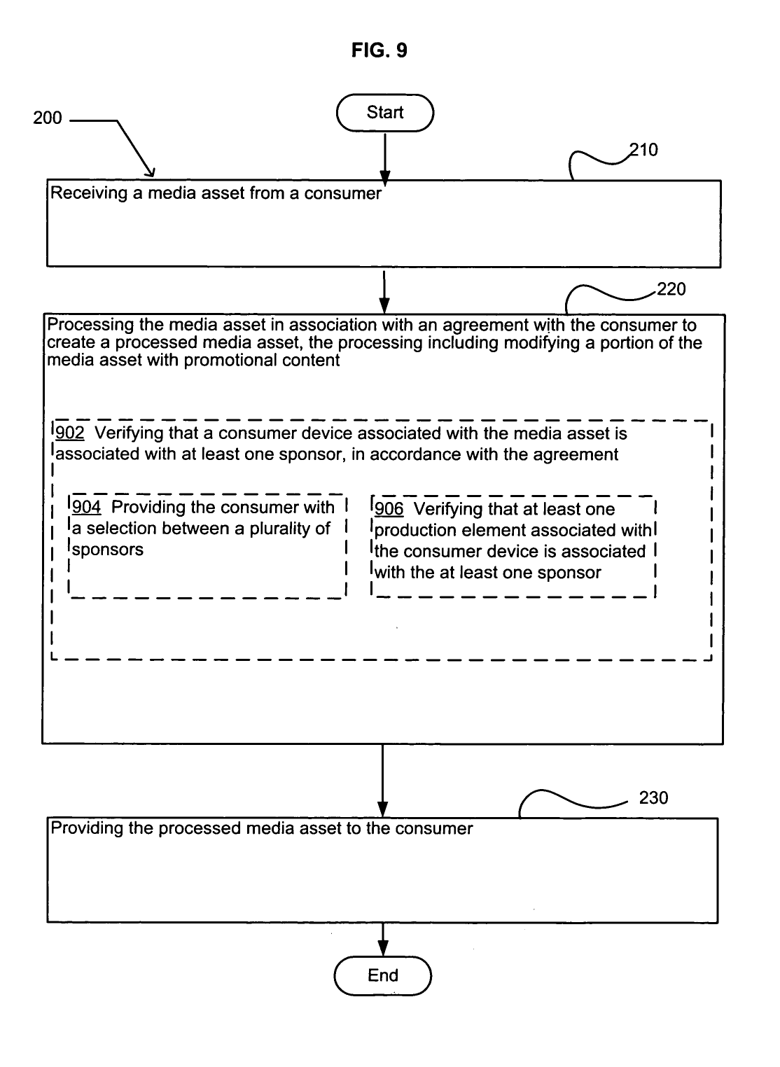

FIG. 9 illustrates an alternative embodiment of the example operational flow 200 of FIG. 2. FIG. 9 illustrates an embodiment where the processing operation 220 may include at least one additional operation. Additional operations may include operation 902, operation 904, and operation 906. At operation 902, a consumer device associated with the media asset is verified as being associated with at least one sponsor, in accordance with the agreement. For example, a consumer may obtain a sponsored camera of a certain sort, and may log onto a website or otherwise connect with a service associated with the sponsored camera. By verifying that in this case, the camera is a sponsored camera, the service may validate that images associated with the camera are entitled to certain processing, in return for inclusion of promotional content, as already described. At operation 904, then, the consumer may be provided with a selection between a plurality of sponsors, so that a selected sponsor is entitled to modify a received image with its own promotional content. Additionally, or alternatively, at operation 906, at least one production element associated with the consumer device is determined to be associated with at least one sponsor. Such production elements may include, for example, printheads or print cartridges of a printer, print paper, or certain software modules associated with a sponsored camera, printer, or other device.

FIG. 10 illustrates an alternative embodiment of the example operational flow 200 of FIG. 2. FIG. 10 illustrates an embodiment where the providing operation 230 may include at least one additional operation. Additional operations may include operation 1000, operation 1002, operation 1004, operation 1006, operation 1008, operation 1010, operation 1012, operation 1014, operation 1016, and operation 1020. At operation 1000, a standard payment amount is determined, based on the modification of the portion with the promotional content. Then, at operation 1020, the processed media content is provided to the consumer in response to receipt of the payment amount.

At operation 1002, a standard payment amount is determined, and, at operation 1004, a discount is applied to the standard payment amount. At operation 1006, the payment amount is determined to be zero, and at operation 1008, the processed media asset is provided to the consumer for free. At operation 1010, a standard payment amount is determined, and, at operation 1012, a premium is applied to the standard payment amount. At operation 1014, the payment amount is assigned based on a presentation of the promotional content within the processed media asset. In an alternative example embodiment, the operation 1014 also may include operation 1016, in which the payment amount is assigned based on a size of the promotional content.

FIG. 11 illustrates an alternative embodiment of the example operational flow 200 of FIG. 2. FIG. 11 illustrates an embodiment where the providing operation 230 may include at least one additional operation. Additional operations may include operation 1102, operation 1104, operation 1106, operation 1108, operation 1110, operation 1112, operation 1114, and operation 1116. At operation 1102, the processed media asset is provided by way of a paper-based print medium. At operation 1104, the processed media asset is provided by way of an electronic display. The operation 1104 may include an alternative embodiment that includes operation 1106, at which the processed media asset is provided on electronic paper. At operation 1108, the processed media asset is provided as a digital media asset. For example, such a digital media asset may be suitable for presentation or other rendering, or may be stored in such form in a digital storage medium, or transmitted to another party, or otherwise may be used as desired by the consumer.

At operation 1110, a request from the consumer to alter the promotional content within the processed media asset is received, and at operation 1112, the processed media asset is re-processed, where the re-processing includes providing an altered media asset with altered promotional content. Then, at operation 1114, the altered media asset may be provided to the consumer. Thus, for example, the consumer may obtain a printed photo with promotional content that includes a corporate logo. The consumer may decide that the logo is too large, or placed badly within the photo, so that the consumer may then wish to obtain another copy of the photo with a preferred inclusion of the promotional content, and, in some examples, embodiments such as those discussed in more detail below, may pay an additional fee to reduce or remove the promotional content in question.

Finally, in FIG. 11, at operation 1116, the media asset is provided according to the agreement in which the consumer agrees to allow the modifying of the media asset in return for other aspects of the processing of the media asset. That is, for example, the consumer may stipulate to a reduced or eliminated pricing plan for a device or a service that renders the processed media asset with the promotional content, or the consumer may agree to exchange inclusion of the promotional content for processing services such as, for example, enhancement, aggregation, or editing of the media asset.

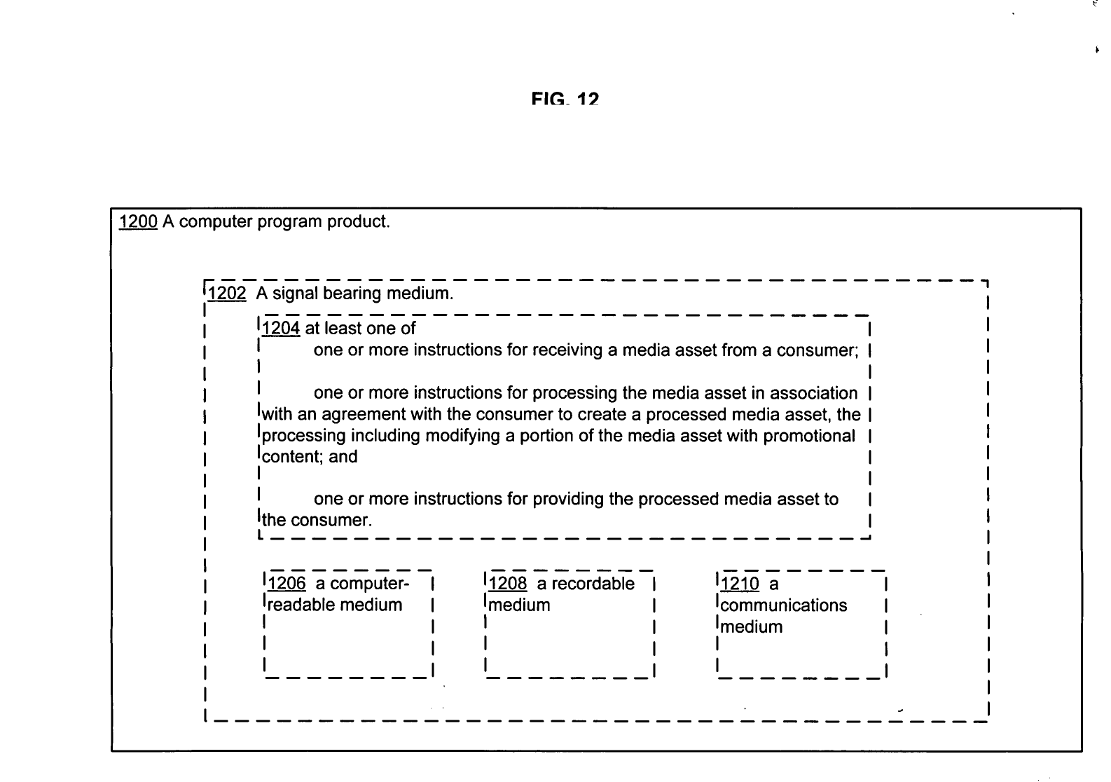

FIG. 12 illustrates a partial view of an exemplary computer program product 1200 that includes a computer program 1204 for executing a computer process on a computing device. An embodiment of the exemplary computer program product 1200 is provided using a signal bearing medium 1202, and may include at least one of one or more instructions for receiving a media asset from a consumer, one or more instructions for processing the media asset in association with an agreement with the consumer to create a processed media asset, the processing including modifying a portion of the media asset with promotional content, and one or more instructions providing the processed media asset to the consumer. The one or more instructions may be, for example, computer executable and/or logic-implemented instructions. In one implementation, the signal-bearing medium 1202 may include a computer-readable medium 1206. In one implementation, the computer-readable medium 1202 may include a recordable medium 1208. In one implementation, the computer-readable medium 1202 may include a communications medium 1210.

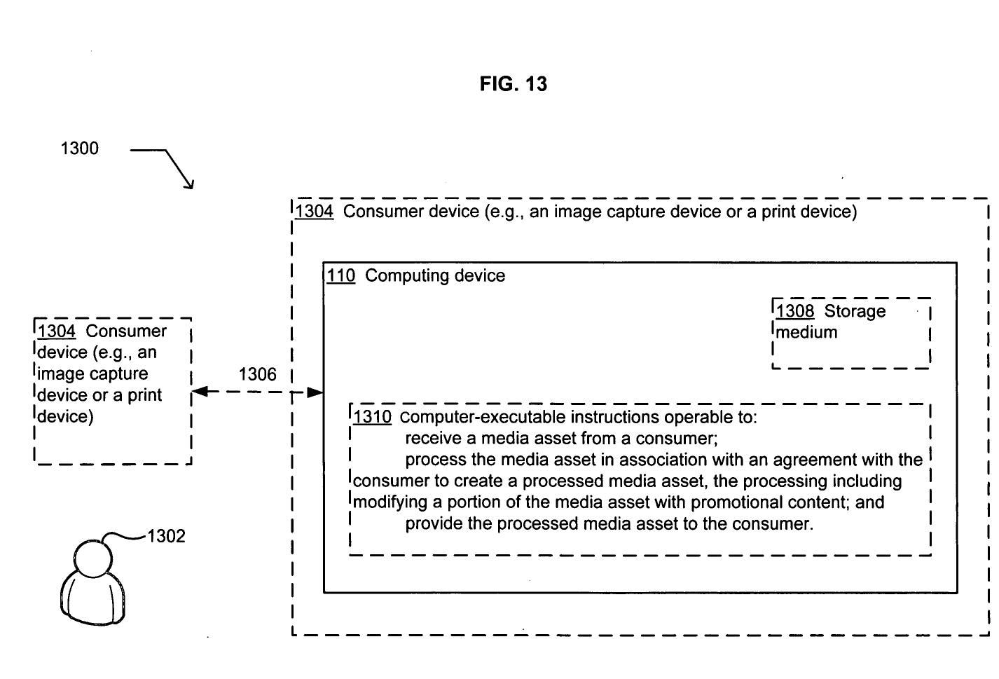

FIG. 13 illustrates an exemplary system 1300 in which embodiments may be implemented. The system 1300 includes a computing system environment, illustrated as the computing system environment 100 of FIG. 1. The system 1300 also illustrates a consumer 1302 using a consumer device 1304, which in some examples may include, as in the examples above, an image capture device, a print device, a general-purpose computing device, or any other device or combination of devices that may be used to store, transmit, display, or render a media asset.

In FIG. 13, the consumer device 1304 is optionally shown as being in communication with the computing device 110 by way of an optional coupling 1306. The optional coupling 1306 may represent a local, wide-area, or peer-to-peer network, or may represent a bus that is internal to a computing device (e.g., in example embodiments in which the computing device is contained in whole or in part within the consumer device 1304. A storage medium 1308 may be any computer storage media.

The computing device 110 includes an operability to receive the media asset. The computing device 110 also includes computer executable instructions 1310 that when executed on the computing device causes the computing device to receive a media asset from a consumer, process the media asset in association with an agreement with the consumer to create a processed media asset, the processing including modifying a portion of the media asset with promotional content, and provide the processed media asset to the consumer.

As referenced above and as shown in FIG. 13, in some examples, the computing device 110 may optionally be contained in whole or in part within the consumer device 1304, and may include an image-capture device or a printer. For example, the consumer device 1304 may include a cell phone, and the computing device 110 may be included as part of a digital camera included within the cell phone. In another example embodiment, the computing device 110 is operable to communicate with the consumer device 1304 associated with the consumer 1302 to receive the media asset from the consumer 1302 and to provide the processed media asset to the consumer 1302.

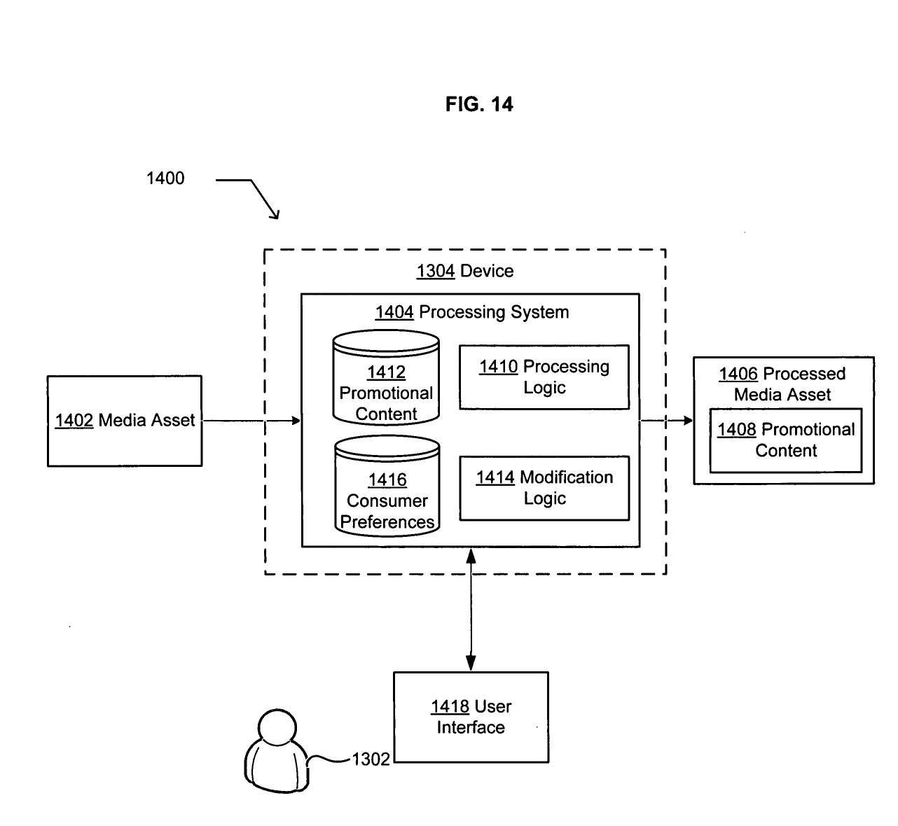

FIG. 14 illustrates another example system 1400 in which embodiments may be implemented, perhaps in the context of a device, e.g., the device 1304 of FIG. 13. In FIG. 14, a media asset 1402 is illustrated as being received at a processing system 1404 associated with the device 1304 and thereafter output by the processing system 1404 as a processed media asset 1406 that includes promotional content 1408.

The processing system 1404 includes processing logic 1410 that is operable to process the media asset 1402 in association with an agreement with the consumer 1302, so as to include the promotional content 1408, such as from, for example, a promotional content memory or database 1412. The processing system 1404, as should be understood from the above description, also may be operable to perform other processing of the media asset 1402, such as, for example, enhancing, editing, displaying, or otherwise improving the media asset 1402, or, in other example embodiments, such additional processing may be performed by other external systems (not shown).

The processing system 1404 also includes modification logic 1414, which communicates with the processing logic 1410 to determine how the promotional content is placed into or onto the media asset 1402. For example, as referenced above, the modification logic 1414 may place the promotional content within a defined area or portion of the media asset 1402, or according to a color scheme of the media asset, or based on an item or object pictured, displayed, or audible within the media asset 1402. In some example embodiments, the modification logic 1414 accesses consumer preferences through a consumer preferences database 1416, so as to modify the media asset 1402 in a manner that is determined by the consumer 1302.

Also in FIG. 14, a user interface 1418 is illustrated that is available to the consumer 1302 for at least the various purposes and uses described above in various contexts. To reiterate a few, the user interface 1418 may be used by the consumer 1302 to set the consumer preferences memory 1416, to select the promotional content 1408, or to select a type of processing (e.g., enhancement) that is required. The user interface 1418 also may be used to select a relative size of the promotional content within the processed media asset 1406, and, in some example embodiments, the selected size of the promotional content may be directly proportional to a cost or payment required from the consumer 1302 for the processed media asset 1406, or, put another way, may be inversely proportional to a discount received by the consumer 1302 for the processed media asset 1406.

As also described above, the promotional content memory 1412 may include promotional content from a number of sources or sponsors, so that the consumer preferences in memory 1416 and/or the user interface 1418 may be used to select between the sources/sponsors. Further, the promotional content 1408 need not be corporate-sponsored advertising, and need not reduce or eliminate a cost associated with obtaining the processed media asset 1406. For example, the consumer 1302 may pay a premium to have certain promotional content included within the processed media asset 1406, such as when, for example, the consumer 1302 wishes to have certain images, which may be enjoyable to the consumer 1302, placed into the media asset 1402.

In FIG. 14, it should be understood that any and/or all of the illustrated elements, and other elements, not illustrated, may be in communication with one another according to any known methods, including but not limited to the various communication techniques discussed above. As such, it should be understood that the various elements need not be located or co-located as illustrated in the example of FIG. 14. For example, in some embodiments, the promotional content memory 1412 and/or the consumer preferences memory 1416 may be remote from the processing system 1404. Similarly, the user interface 1418 may be implemented at a local computing device of the consumer 1302, remote from the processing system 1404, or may be a part of the device 1304 that may house the processing system 1404, as well.

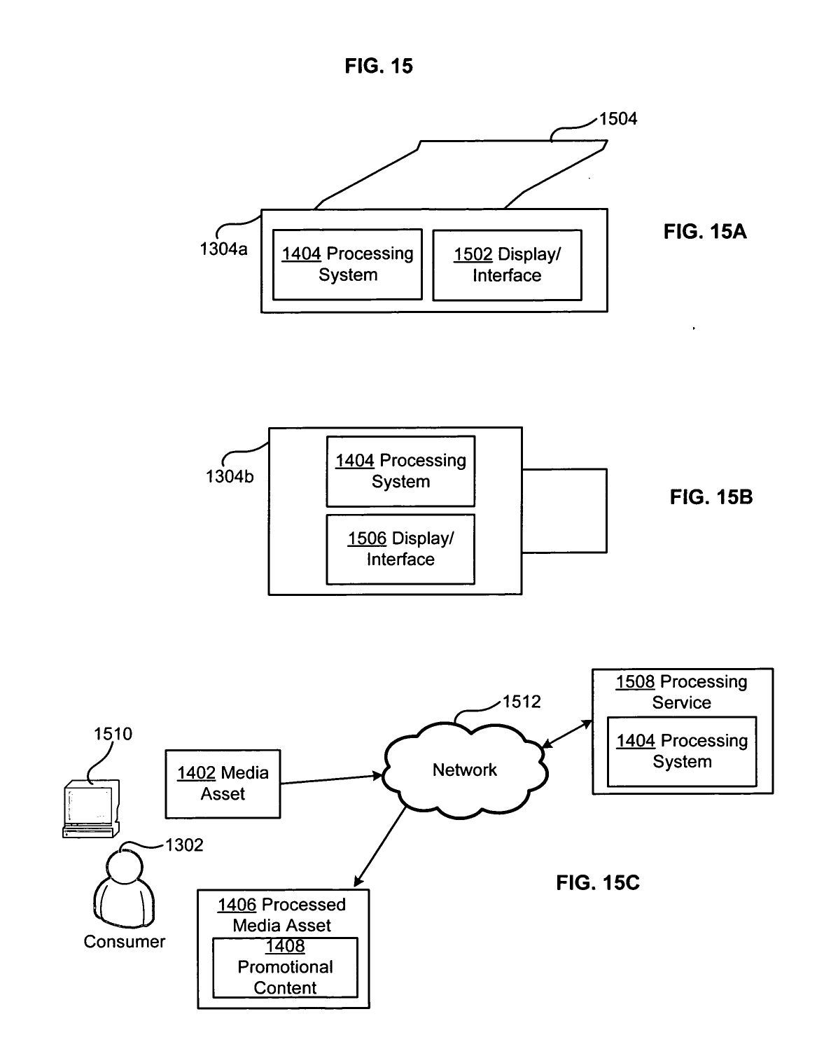

FIGS. 15A-15C illustrate certain alternative embodiments of the device and/or processing system of FIG. 14. In FIG. 15A, the device 1304 (e.g., FIG. 13) is illustrated as a printer 1304a, which includes the processing system 1404 and a display 1502. The display 1502 may be used to display a preview of a media asset to be printed with the printer 1304a, such as, for example, the processed media asset 1406, and, of course, the printer 1304a may be used to print the processed media asset on paper 1504, as well. The display 1502 also should be understood to function, in some example embodiments, as the user interface 1418. For example, the display 1502 may include touch-screen control for operating the printer 1304a and/or the processing system 1404, or various buttons, keys, or other selection/input devices (not shown) may be used. In additional or alternative embodiments, an external computing device may be connected to the printer 1304a for control thereof, including control of the processing system 1404.

In FIG. 15B, the device 1304 (e.g., FIG. 13) is illustrated as a camera 1304b, which, similarly to the printer 1304a, includes some or all of the processing system 1404, as well as a display 1506. As with the printer 1304a, the camera 1304b (and/or the processing system 1404) may be controlled by the consumer 1302, either using the display 1506 (and possibly associated controls) or using an external computing device.

In FIG. 15C, the processing system 1404 is illustrated as part of a processing service 1508, which may be remote from the consumer 1302 at a computing station 1510, and in communication therewith by way of a network 1512. In such example embodiments, the consumer 1302 may use the workstation 1510 to transmit and receive the media asset 1402 and the processed media asset 1406, respectively, in order to obtain the various advantages described herein.

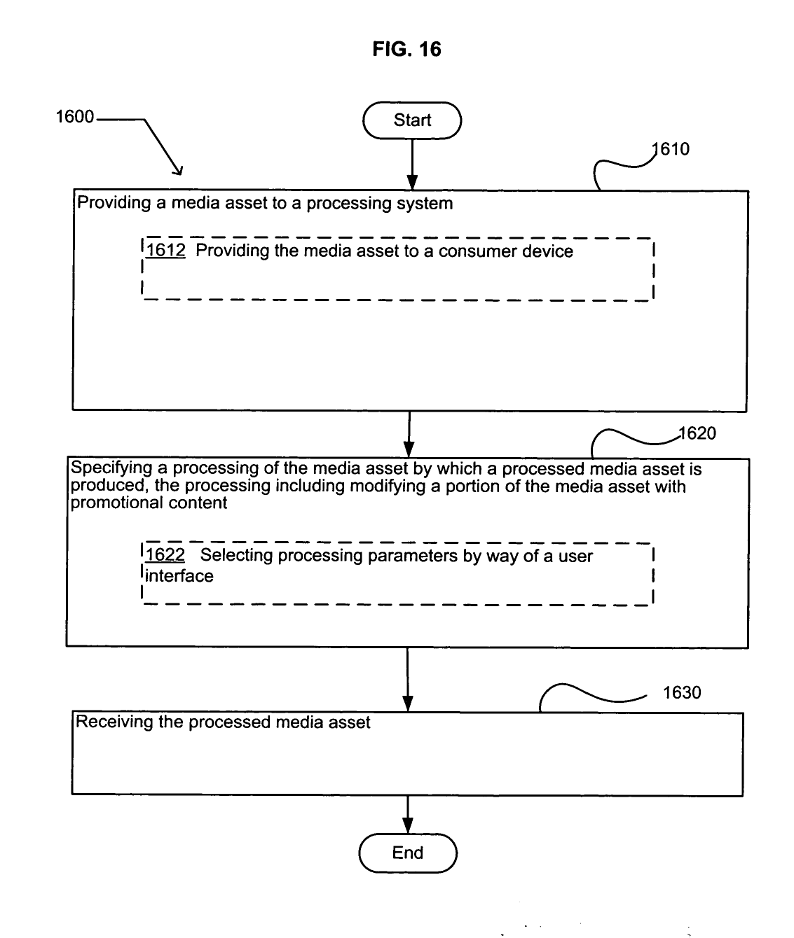

FIG. 16 illustrates an operational flow 1600 representing example operations by which a consumer obtains a processed media asset that includes promotional content. At operation 1610, a consumer provides a media asset to a processing system. At operation 1620, the consumer specifies a processing of the media asset by which a processed media asset is produced, the processing including modifying a portion of the media asset with promotional content. At operation 1630, the consumer receives the processed media asset.

Also in FIG. 16, operation 1610 illustrates an alternative embodiment in which additional operations may be included. For example, the providing operation 1610 includes an operation 1612 in which the consumer provides the media asset to a consumer device, such as, for example, a camera, a printer, a memory device, or a general purpose computing device. Also, operation 1620 includes an alternative embodiment in which, at operation 1622, the consumer selects processing parameters by way of a user interface.

While certain features of the described implementations have been illustrated as disclosed herein, many modifications, substitutions, changes and equivalents will now occur to those skilled in the art. It is, therefore, to be understood that the appended claims are intended to cover all such modifications and changes as fall within the true spirit of the embodiments of the invention.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components.

1. A method comprising:
receiving a media asset from a consumer;
processing the media asset in association with an agreement with the consumer to create a processed media asset, the processing including modifying a portion of the media asset with promotional content; and
providing the processed media asset to the consumer.

2. The method of claim 1 wherein receiving a media asset from a consumer comprises:
receiving the media asset as captured by a consumer image capture device.

3. (canceled)

4. (canceled)

5. The method of claim 1 wherein processing the media asset in association with an agreement with the consumer to create a processed media asset comprises:
determining that a consumer image capture device is associated with the promotional content.

6. The method of claim 1 wherein providing the processed media asset to the consumer comprises:
displaying the processed media asset as an image on a display screen associated with a consumer image capture device.

7. (canceled)

8. The method of claim 1 wherein processing the media asset in association with an agreement with the consumer to create a processed media asset, the processing including modifying a portion of the media asset with promotional content comprises:
determining that a printer is associated with the promotional content.

9. (canceled)

10. The method of claim 1 wherein receiving a media asset from a consumer comprises:
receiving the media asset at a consumer device.

11. The method of claim 1 wherein receiving a media asset from a consumer comprises:
receiving an audio file from the consumer.

12. The method of claim 1 wherein receiving a media asset from a consumer comprises:
receiving the media asset at a processing system.

13. (canceled)

14. The method of claim 1 wherein receiving a media asset from a consumer comprises:
receiving the media asset as stored on a memory device.

15. The method of claim 1 wherein processing the media asset in association with an agreement with the consumer to create a processed media asset comprises:
determining that the portion of the media asset includes a target location within the media asset for the promotional content.

16. The method of claim 15 wherein determining that the portion of the media asset includes a target location within the media asset for the promotional content comprises:
determining the target location within an image at which image content is at least partially replaced by the promotional content.

17. The method of claim 15 wherein determining that the portion of the media asset includes a target location within the media asset for the promotional content comprises:
selecting the target location based on placement logic defining criteria for the selecting of the target location.

18. (canceled)

19. The method of claim 15 wherein determining that the portion of the media asset includes a target location within the media asset for the promotional content comprises:
determining a preference of the consumer with respect to the target location.

20. The method of claim 15 wherein determining that the portion of the media asset includes a target location within the media asset for the promotional content comprises:
replacing image content at the target location with promotional image content based on a shape of the image content within the media asset.

21. The method of claim 15 wherein determining that the portion of the media asset includes a target location within the media asset for the promotional content comprises:
replacing image content at the target location with promotional image content based on an orientation of the image content within the media asset.

22. The method of claim 15 wherein determining that the portion of the media asset includes a target location within the media asset for the promotional content comprises:
removing image content at the target location.

23. The method of claim 15 wherein determining that the portion of the media asset includes a target location within the media asset for the promotional content comprises:
overlaying image content at the target location with translucent promotional image content that at least partially obscures the image content.

24. The method of claim 1 wherein processing the media asset in association with an agreement with the consumer to create a processed media asset comprises:
aggregating the media asset with a plurality of media assets included in the processed media asset.

25. The method of claim 1 wherein processing the media asset in association with an agreement with the consumer to create a processed media asset comprises:
enhancing a quality of the media asset.

26. (canceled)

27. The method of claim 1 wherein processing the media asset in association with an agreement with the consumer to create a processed media asset comprises:
processing the media asset within a processing system.

28. The method of claim 27 wherein processing the media asset within a processing system comprises:
processing the media asset within the processing system of a consumer device.

29. The method of claim 28 wherein processing the media asset within the processing system of a consumer device comprises:
processing the media asset based on a payment amount for the consumer device, the payment amount being determined as part of the agreement with the consumer.

30. The method of claim 27 wherein processing the media asset within a processing system comprises:
processing the media asset within the processing system of a processing service.

31. The method of claim 1 wherein processing the media asset in association with an agreement with the consumer to create a processed media asset comprises:
verifying that a consumer device associated with the media asset is associated with at least one sponsor, in accordance with the agreement.

32. The method of claim 31 wherein verifying that a consumer device associated with the media asset is associated with at least one sponsor comprises:
providing the consumer with a selection between a plurality of sponsors.

33. The method of claim 31 wherein verifying that a consumer device associated with the media asset is associated with at least one sponsor comprises:
verifying that at least one production element associated with the consumer device is associated with the at least one sponsor.

34. The method of claim 1 wherein providing the processed media asset to the consumer comprises:
determining a payment amount, based on the modifying of the portion with the promotional content; and
providing the processed media content to the consumer in response to receipt of the payment amount.

35. The method of claim 34 wherein determining the payment amount comprises:
determining a standard payment amount; and
applying a discount to the standard payment amount.

36. The method of claim 34 wherein determining the payment amount comprises:
determining the payment amount to be zero; and
providing the processed media asset to the consumer for free.

37. The method of claim 34 wherein determining the payment amount comprises:
determining a standard payment amount; and
applying a premium to the standard payment amount.

38. The method of claim 34 wherein determining the payment amount comprises:
assigning the payment amount based on a presentation of the promotional content within the processed media asset.

39. (canceled)

40. The method of claim 1 wherein providing the processed media asset comprises:
providing the processed media asset by way of a paper-based print medium.

41. The method of claim 1 wherein providing the processed media asset comprises:
providing the processed media asset by way of an electronic display.

42. The method of claim 41 wherein providing the processed media asset by way of an electronic display comprises:
providing the processed media asset on electronic paper.

43. The method of claim 1 wherein providing the processed media asset comprises:
providing the processed media asset as a digital media asset.

44. The method of claim 1 wherein providing the processed media asset comprises:
receiving a request from the consumer to alter the promotional content within the processed media asset;
re-processing the processed media asset, the re-processing including providing an altered media asset with altered promotional content; and
providing the altered media asset.

45. The method of claim 1 wherein providing the processed media asset comprises:
providing the processed media asset according to the agreement in which the consumer agrees to allow the modifying of the portion of the media asset in return for other aspects of the processing of the media asset.

46. A computer program product comprising: a signal-bearing medium bearing at least one of one or more instructions for receiving a media asset from a consumer, one or more instructions for processing the media asset in association with an agreement with the consumer to create a processed media asset, the processing including modifying a portion of the media asset with promotional content, or one or more instructions for providing the processed media asset to the consumer.

47. (canceled)

48. (canceled)

49. (canceled)

50. A system comprising:
a computing device; and
instructions that when executed on the computing device cause the computing device to:
receive a media asset from a consumer;
process the media asset in association with an agreement with the consumer to create a processed media asset, the processing including modifying a portion of the media asset with promotional content; and/or
provide the processed media asset to the consumer.

51. (canceled)

52. (canceled)

53. (canceled)

54. A device comprising:
a processing system, the processing system comprising:
processing logic operable to process a media asset in association with an agreement with a consumer to create a processed media asset, and modification logic operable to modify a portion of the media asset based on promotional content for inclusion in the processed media asset as provided to the consumer.

55. (canceled)

56. (canceled)

57. (canceled)

58. (canceled)

59. (canceled)

60. A method comprising:
providing a media asset to a processing system;
specifying a processing of the media asset by which a processed media asset is produced, the processing including modifying a portion of the media asset with promotional content; and
receiving the processed media asset.

61. (canceled)

62. (canceled)
